(19) United States
(12) Patent Application Publication
(10) Pub. No.: US 2024/0182623 A1
(43) Pub. Date: Jun. 6, 2024

(54) METHOD OF PRODUCING BLOCK COPOLYMER, AND BLOCK COPOLYMER

(71) Applicant: TOKYO OHKA KOGYO CO., LTD., Kawasaki-shi (JP)

(72) Inventors: Toshifumi Satoh, Sapporo-shi (JP); Takuya Isono, Sapporo-shi (JP); Kazushige Suzuki, Sapporo-shi (JP); Toi Iizuka, Sapporo-shi (JP); Ken Miyagi, Kawasaki-shi (JP); Takahiro Dazai, Kawasaki-shi (JP)

(21) Appl. No.: 18/512,901

(22) Filed: Nov. 17, 2023

(30) Foreign Application Priority Data
Nov. 22, 2022 (JP) 2022-186472

(51) Int. Cl. C08F 299/00

(52) U.S. Cl. CPC C08F 299/00

(57) ABSTRACT

A method of producing a triblock copolymer, the method including reacting a diblock copolymer that contains a first block formed from a repeating structure including a constituent unit containing an aromatic hydrocarbon group, and a second block formed from a repeating structure including a constituent unit derived from an α-substituted acrylic acid ester with a homopolymer that contains a third block formed from a repeating structure including a constituent unit containing an aromatic hydrocarbon group and containing a hydroxy group bonded to a terminal of a main chain in the third block to obtain a triblock copolymer, in which the reaction is transesterification of the constituent unit derived from an (α-substituted) acrylic acid ester at a terminal of a main chain of the diblock copolymer with the homopolymer.

### BACKGROUND OF THE INVENTION

### Field of the Invention

The present invention relates to a method of producing a block copolymer and a block copolymer.

Priority is claimed on Japanese Patent Application No. 2022-186472, filed on Nov. 22, 2022, the content of which is incorporated herein by reference.

### Description of Related Art

In recent years, as further miniaturization of large scale integrated circuits (LSI) proceeds, a technology for processing a more delicate structure has been demanded.

In response to such a demand, there has been developed a technology for forming a finer pattern using a phase-separated structure formed by self-assembly of block copolymers having incompatible blocks bonded to each other (see, for example, Japanese Unexamined Patent Application, First Publication No. 2008-36491).

The block copolymer is separated (phase-separated) in micro regions due to repulsion between blocks incompatible with each other, and subjected to the heat treatment or other processing to form a structure containing a regular periodic structure. Specific examples of this periodic structure include a cylinder (columnar phase), a lamella (plate phase), and a sphere (spherical phase), and other structures.

In order to utilize the phase-separated structure of the block copolymer, it is necessary to form a self-assembly nanostructure by a microphase separation only in a specific region and arrange the nanostructure in a desired direction. In order to achieve these position control and orientation control, processes to control a phase-separated pattern by a guide pattern such as graphoepitaxy, and processes to control a phase-separated pattern by a difference in the chemical state of a substrate such as chemical epitaxy have been proposed (see, for example, Proceedings of SPIE, Vol. 7637, No. 76370G-1 (2010)).

In regard to a method of forming a pattern using a phase-separated structure formed by self-assembly of block copolymers, it is necessary to prepare a block copolymer with L0 (=Mn) corresponding to one pitch. Therefore, it is necessary to prepare block copolymers individually for designing a plurality of pitches.

In the above-described pattern formation method, in a case where one block copolymer can be used for a plurality of pitches, the applicable range of the method of forming a pattern is greatly expanded.

Therefore, in the above-described method of forming a pattern, improvement of a process margin is required.

From the viewpoint of further improving the process margin, a triblock polymer obtained by the addition of one block to a conventional diblock polymer has been developed.

For example, it is disclosed in PCT International Publication No. WO2015/046510 that a triblock polymer contains a polymer block composed of a structural unit derived from a vinyl aromatic compound, a polymer block composed of a structural unit derived from a conjugated diene, and a polymer block composed of a structural unit derived from a (meth)acrylic acid alkyl ester having a chain-like or cyclic alkyl group having 1 to 20 carbon atoms. In addition, as a method of producing the triblock polymer, a production method of carrying out an anionic polymerization on a vinyl aromatic compound, a conjugated diene, and an (meth)acrylic acid alkyl ester having a chain-like or cyclic alkyl group having 1 to 20 carbon atoms in this order is disclosed.

### SUMMARY OF THE INVENTION

However, depending on a monomer to be used, each monomer may not be subjected to the step polymerization as described in PCT International Publication No. WO2015/046510.

For example, a triblock polymer (PS-b-PMMA-b-PS′) containing two blocks composed of styrene and a block composed of methyl methacrylate cannot be synthesized by a living anionic polymerization. This is because, in general, PMMA polymerization is carried out by reacting 1,1-diphenylethylene with the active terminal to reduce nucleophilicity while suppressing a side reaction since the side reaction to a carbonyl group in PMMA occurs due to the high nucleophilicity of the PS active terminal, but thereafter, the polymerization of styrene, which requires high nucleophilicity, does not proceed.

In addition, in a case where a triblock polymer is produced by living anionic polymerization that enables the narrowest dispersity, the metal Na or K is generally used as an initiator at both terminals. Thus, there is an issue that mass production cannot be achieved from the viewpoint of safety.

The present invention has been made in view of the above circumstances, and an object of the present invention is to provide a method of producing a block copolymer that enables mass production of a block copolymer that is a triblock copolymer, and a block copolymer obtained by the production method.

A first aspect of the present invention is a method of producing a block copolymer that is a triblock copolymer, the method including a step of reacting a block copolymer that is a diblock copolymer and contains a first block formed from a repeating structure composed of a constituent unit containing an aromatic hydrocarbon group, and a second block formed from a repeating structure composed of a constituent unit derived from an (α-substituted) acrylic acid ester with a homopolymer that contains a third block formed from a repeating structure composed of a constituent unit containing an aromatic hydrocarbon group and contains a hydroxy group bonded to a terminal of a main chain in the third block to obtain a triblock copolymer, in which the reaction is transesterification of the constituent unit derived from an (α-substituted) acrylic acid ester at a terminal of a main chain of the diblock copolymer with the homopolymer.

A second aspect of the present invention is a block copolymer containing a first block, a second block, and a third block, which are bonded to one another, in which the first block and the third block are composed of a polymer having a repeating structure composed of a constituent unit containing an aromatic hydrocarbon group, the second block is composed of a polymer having a repeating structure composed of a constituent unit derived from an (α-substituted) acrylic acid ester, and the third block is bonded to a side chain of the second block via a linking group containing an ester bond.

According to the present invention, an object thereof is to provide the method of producing a block copolymer that enables mass production of the block copolymer that is a triblock copolymer, and the block copolymer obtained by the production method.

### DETAILED DESCRIPTION OF THE INVENTION

In the present specification and claims, the term “aliphatic” is defined as a relative concept to aromatic, and means a group, a compound, and the like having no aromaticity.

Unless otherwise specified, the term “alkyl group” is intended to encompass linear, branched, and cyclic monovalent saturated hydrocarbon groups. The same applies to an alkyl group in an alkoxy group.

Unless otherwise specified, the term “alkylene group” is intended to encompass linear, branched, and cyclic divalent saturated hydrocarbon groups.

The term “halogenated alkyl group” is a group obtained by substituting all or some of hydrogen atoms in an alkyl group with a halogen atom, and examples of the halogen atom include a fluorine atom, a chlorine atom, a bromine atom, and an iodine atom.

The term “fluorinated alkyl group” or “fluorinated alkylene group” is a group obtained by substituting all or some of hydrogen atoms in an alkyl group or an alkylene group with a fluorine atom.

The term “constituent unit” means a monomer unit constituting a polymer compound (resin, polymer, and copolymer).

The phrase “constituent unit derived from” means a constituent unit that is formed by the cleavage of an ethylenic double bond.

The case where it is described as “which may have a substituent” includes both a case where a hydrogen atom (—H) is substituted with a monovalent group and a case where a methylene group (—CH₂—) is substituted with a divalent group.

The term “exposure” is a concept including general irradiation with radiation.

The term “α-position (carbon atom at α-position)” means a carbon atom to which a side chain of a block copolymer is bonded, unless otherwise specified. The “carbon atom at the α-position” of a methyl methacrylate unit means a carbon atom to which a carbonyl group of methacrylic acid is bonded. The “carbon atom at the α-position” of a styrene unit means a carbon atom to which a benzene ring is bonded.

The term “number-average molecular weight” (Mn) is a number-average molecular weight in terms of standard polystyrene measured by size-exclusion chromatography, unless otherwise specified.

The term “weight-average molecular weight” (Mw) is a weight-average molecular weight in terms of standard polystyrene measured by size-exclusion chromatography, unless otherwise specified. The value of adding a unit (gmol⁻) to the value of Mn or Mw represents a molar mass.

In the present specification and claims, an asymmetric carbon may be present depending on a structure represented by a chemical formula, and an enantiomer or a diastereomer may be present. In these cases, these isomers are represented by one formula. These isomers may be used alone or used as a mixture.

In the present specification, the term “period of structure” means a period of a phase structure observed when a structure of a phase-separated structure is formed and refers to the sum of lengths of the phases each of which is incompatible. In a case where the phase-separated structure forms a cylinder structure perpendicular to a surface of a substrate, a period (L0) of the structure is a distance (pitch) between centers of two adjacent cylinder structures.

It is known that the period (L0) of the structure is determined by inherent polymerization properties such as the degree of polymerization N and interaction parameter χ of Flory-Huggins. That is, the larger the product “χ×N” of χ and N is, the greater the interactive repulsion between the different blocks in the block copolymer becomes. Therefore, in a case of the relation of χ×N>10.5 (hereinafter, referred to as “strong separation limit”), the repulsion between the different kinds of blocks in the block copolymer is large, and the tendency for phase separation to occur becomes strong. Accordingly, in the strong separation limit, the period of the structure is approximately N^{2/3}×χ^{1/6}, and satisfies the relationship of the following equation (cy). That is, the period of the structure is proportional to the degree of polymerization N, which correlates with the molecular weight and the molecular weight ratio between the different blocks.

L0∝a×N^{2/3}×χ^{1/6} (cy)

[In expression, L0 represents a period of the structure. a is a parameter indicating the size of the monomer. N represents a degree of polymerization. χ is an interaction parameter, and the higher the value thereof, the higher the phase separation performance.]

Accordingly, the period (L0) of the structure can be controlled by adjusting the composition and the total molecular weight of the block copolymer.

### Method of Producing Block Copolymer

A method of producing a block copolymer that is a triblock copolymer of the present embodiment includes a step of reacting a block copolymer that is a diblock copolymer and contains a first block formed from a repeating structure composed of a constituent unit containing an aromatic hydrocarbon group, and a second block formed from a repeating structure composed of a constituent unit derived from an (α-substituted) acrylic acid ester with a homopolymer that contains a third block formed from a repeating structure composed of a constituent unit containing an aromatic hydrocarbon group and contains a hydroxy group bonded to a terminal of a main chain in the third block to obtain a triblock copolymer, and in the step, the reaction is transesterification of the constituent unit derived from an (α-substituted) acrylic acid ester at a terminal of a main chain of the diblock copolymer with the homopolymer.

### Block Copolymer that is Diblock Copolymer

The block copolymer that is a diblock copolymer in the method of producing a block copolymer of the present embodiment contains the first block formed from the repeating structure composed of the constituent unit containing an aromatic hydrocarbon group, and the second block formed from the repeating structure composed of the constituent unit derived from an (α-substituted) acrylic acid ester.

In the diblock copolymer, the mass ratio of the first block to the second block (the mass of the first block: the mass of the second block) is 25:75 to 75:25, more preferably 30:70 to 70:30, and still more preferably 40:60 to 60:40.

In a case where the mass ratio of the first block to the second block in the diblock copolymer is within the above-described preferable range, the process margin can be further improved, and the occurrence of defects can be further suppressed.

The number-average molecular weight (Mn) of the diblock copolymer is preferably 20,000 to 200,000, more preferably 30,000 to 100,000, and still more preferably 36,000 to 80,000.

A number-average molecular weight (Mn1) of the polymer constituting the first block in the diblock copolymer (hereinafter simply referred to as “Mn1”) is preferably 10,000 to 100,000, more preferably 15,000 to 50,000, and still more preferably 18,000 to 40,000.

In a case where Mn1 is within the above-described preferable range, the process margin is more likely to be improved, and the occurrence of defects is more easily suppressed.

A number-average molecular weight (Mn2) of the polymer constituting the second block in the diblock copolymer (hereinafter simply referred to as “Mn2”) is preferably 10,000 to 100,000, more preferably 15,000 to 50,000, and still more preferably 18,000 to 40,000.

In a case where Mn2 is within the above-described preferable range, the process margin is more likely to be improved, and the occurrence of defects is more easily suppressed.

### <<Constituent Unit Containing Aromatic Hydrocarbon Group>>

In a constituent unit containing an aromatic hydrocarbon group, the aromatic hydrocarbon group is a hydrocarbon group containing at least one aromatic ring.

This aromatic ring is not limited as long as it is a cyclic conjugated system having (4n+2) π electrons, and may be an aromatic heterocyclic ring obtained by substituting some of carbon atoms, which constitute an aromatic hydrocarbon ring, with heteroatoms.

Specific examples of the aromatic hydrocarbon group in the constituent unit containing the aromatic hydrocarbon group include a phenyl group and a naphthyl group.

Among these, as the constituent unit containing an aromatic hydrocarbon group, a constituent unit derived from styrene, a derivative of the styrene, 1-vinylnaphthalene, 4-vinylbiphenyl, 1-vinyl-2-pyrrolidone, 9-vinylanthracene, or vinylpyridine is preferred, and a constituent unit derived from styrene or a derivative of the styrene is more preferred. Specific examples of styrene or a derivative of the styrene include α-methylstyrene, 2-methylstyrene, 3-methylstyrene, 4-methylstyrene, 4-t-butylstyrene, 4-n-octylstyrene, 2,4,6-trimethylstyrene, 4-methoxystyrene, 4-t-butoxystyrene, 4-hydroxystyrene, 4-nitrostyrene, 3-nitrostyrene, 4-chlorostyrene, 4-fluorostyrene, 4-acetoxyvinyl styrene, 4-chloromethylstyrene, and the like.

<<Constituent Unit Derived from (α-Substituted) Acrylic Acid Ester>>

In the present specification, the term “(α-substituted) acrylic acid ester” encompasses an acrylic acid ester and an acrylic acid ester obtained by substituting a hydrogen atom bonded to a carbon atom at an α-position with a substituent.

Specific examples of the (α-substituted) acrylic acid ester include acrylic acid esters such as methyl acrylate, ethyl acrylate, propyl acrylate, n-butyl acrylate, t-butyl acrylate, cyclohexyl acrylate, octyl acrylate, nonyl acrylate, hydroxyethyl acrylate, hydroxypropyl acrylate, benzyl acrylate, anthracene acrylate, glycidyl acrylate, 3,4-epoxycyclohexylmethane acrylate, and propyltrimethoxysilane acrylate; and methacrylic acid esters such as methyl methacrylate, ethyl methacrylate, propyl methacrylate, n-butyl methacrylate, t-butyl methacrylate, cyclohexyl methacrylate, octyl methacrylate, nonyl methacrylate, hydroxyethyl methacrylate, hydroxypropyl methacrylate, benzyl methacrylate, anthracene methacrylate, glycidyl methacrylate, 3,4-epoxycyclohexylmethane methacrylate, and propyltrimethoxysilane methacrylate.

Among these, as the (α-substituted) acrylic acid ester, methyl acrylate, ethyl acrylate, t-butyl acrylate, methyl methacrylate, ethyl methacrylate, and t-butyl methacrylate are preferred, and methyl methacrylate is more preferred.

Specific examples of the block copolymer that is a diblock copolymer in the method of producing a block copolymer of the present embodiment include a block copolymer that has a block composed of a constituent unit derived from styrene and a block composed of a constituent unit derived from methyl acrylate: a block copolymer that has a block composed of a constituent unit derived from styrene and a block composed of a constituent unit derived from ethyl acrylate; a block copolymer that has a block composed of a constituent unit derived from styrene and a block composed of a constituent unit derived from t-butyl acrylate; a block copolymer that has a block composed of a constituent unit derived from styrene and a block composed of a constituent unit derived from methyl methacrylate; a block copolymer that has a block composed of a constituent unit derived from styrene and a block composed of a constituent unit derived from ethyl methacrylate; a block copolymer that has a block composed of a constituent unit derived from styrene and a block composed of a constituent unit derived from t-butyl methacrylate, and other block copolymers.

Among these, the block copolymer is preferably a block copolymer that has a block composed of a constituent unit derived from styrene and a block composed of a constituent unit derived from methyl methacrylate.

### Homopolymer Containing Third Block That has Repeating Structure Composed of Constituent Unit Containing Aromatic Hydrocarbon Group and has Hydroxy Group Bonded to Terminal of Main Chain in Third Block

The homopolymer in the method of producing a block copolymer of the present embodiment contains the third block that has a repeating structure composed of a constituent unit containing an aromatic hydrocarbon group and has the hydroxy group bonded to a terminal of a main chain in the third block.

Examples of the constituent unit containing an aromatic hydrocarbon group include the same constituent units as those containing an aromatic hydrocarbon group in the first block described above.

The structure of the constituent unit of the polymer constituting the first block may be identical to or may be different from the structure of a constituent unit of a polymer constituting the third block, but it is preferable that the structures are identical to each other, and it is more preferable that the structure of the constituent unit of the polymer constituting the first block is identical to the structure of the constituent unit of the polymer constituting the third block, and the number-average molecular weight (Mn3) of the polymer constituting the third block is smaller than the number-average molecular weight (Mn1) of the polymer constituting the first block.

Specific examples of the homopolymer include a homopolymer represented by General Formula (h1).

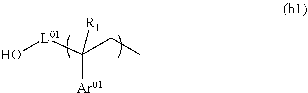

[In the formula, R¹ represents a hydrogen atom, an alkyl group having 1 to 5 carbon atoms, or a halogenated alkyl group having 1 to 5 carbon atoms. Ar⁰¹ represents an aromatic hydrocarbon group. L⁰¹ represents a divalent linking group.]

In General Formula (h1), R¹ is a hydrogen atom, an alkyl group having 1 to 5 carbon atoms, or a halogenated alkyl group having 1 to 5 carbon atoms, and preferably a hydrogen atom.

In General Formula (h1), Ar⁰¹ is an aromatic hydrocarbon group, and examples thereof include the same groups as the aromatic hydrocarbon groups in <<Constituent Unit Containing Aromatic Hydrocarbon Group>> described above.

Among these, Ar⁰¹ is preferably a phenyl group.

L⁰¹ in General Formula (h1) is a divalent linking group, and preferably an alkylene group having 1 to 10 carbon atoms.

Specific examples of the alkylene group having 1 to 10 carbon atoms include linear alkylene groups such as a methylene group [—CH₂—], an ethylene group [—(CH₂)₂—], a trimethylene group [—(CH₂)₃—], a tetramethylene group [—(CH₂)₄—], a pentamethylene group [—(CH₂)₅—]: branched alkylene groups such as alkylalkylene groups such as an alkylmethylene group such as —CH(CH₃)—, —CH(CH₂CH₃)—, —C(CH₃)₂—, —C(CH₃)(CH₂CH₃)—, —C(CH₃)(CH₂CH₂CH₃)—, or —C(CH₂CH₃)₂—, an alkylethylene group such as —CH(CH₃)CH₂—, —CH(CH₃)CH(CH₃)—, —C(CH₃)₂CH₂—, —CH(CH₂CH₃)CH₂—, or —C(CH₂CH₃)—CH₂—, an alkyltrimethylene group such as —CH(CH₃)CH₂CH₂— or —CH₂CH(CH₃)CH₂—, an alkyltetramethylene group such as —CH(CH₃)CH₂CH₂CH₂— or —CH₂CH(CH₃)CH₂CH₂—.

Among these, L⁰¹ in General Formula (e1) is preferably a linear alkylene group having 1 to 10 carbon atoms, more preferably a linear alkylene group having 1 to 5 carbon atoms, and still more preferably a linear alkylene group having 2 to 5 carbon atoms.

The number-average molecular weight (Mn3) of the homopolymer (the polymer constituting the third block) (hereinafter, simply referred to as “Mn3”) is preferably 1,200 to 11,500, more preferably 1,500 to 11,000, and still more preferably 1,800 to 10,500.

In a case where Mn3 is the above-described preferred lower limit or more, the period (L0) of the structure can be made smaller, and a finer pattern can be formed.

In addition, in a case where Mn3 is the above-described preferred upper limit or less, the thermal motility is appropriately maintained, and the occurrence of defects can be further suppressed.

In this step, the block copolymer is preferably reacted with the homopolymer such that the mass ratio of the first block and third block to the second block (the mass of the first block and third block: the mass of the second block) is preferably 25:75 to 75:25, more preferably 30:70 to 70:30, and still more preferably 40:60 to 60:40.

The reaction between the block copolymer and the homopolymer to obtain the above-described preferable mass ratio enables the process margin to be further improved and the occurrence of defects to be further suppressed.

The mass ratio of the first block and third block to the second block (the mass of the first block and third block: the mass of the second block) can be calculated by ¹H-NMR.

In this step, the block copolymer is preferably reacted with the homopolymer such that Mn1:Mn3 is preferably 1:0.05 to 1:0.35, more preferably 1:0.06 to 1:0.35, and still more preferably 1:0.07 to 1:0.35.

The reaction between the block copolymer and the homopolymer to obtain the above-described preferable mass ratio enables the process margin to be further improved and the occurrence of defects to be further suppressed.

Mn1, Mn2, and Mn3 of the block copolymer can be calculated by, for example, the following methods.

For example, in a case where the block copolymer is PS-b-PMMA-b-PS′, and PS′ is bonded to a side chain of PMMA, PS-b-PMMA and PS′ can be separated from each other by hydrolysis. Mn3 can be calculated for the polymer PS′ constituting the third block by size-exclusion chromatography. In addition, a number-average molecular weight Mn12 of the block copolymer containing the first block and the second block can also be calculated. Regarding the block copolymer containing the first block and the second block, the ratio between a polymer constituting the first block and a polymer constituting the second block in the block copolymer can be calculated by ¹H-NMR. Thus, Mn1 and Mn2 can be calculated from Mn12 described above.

In addition, in a case where the number-average molecular weight (Mn) of the block copolymer and the constituent unit of the polymer constituting each block are known through ¹H-NMR, Mn1, Mn2, and Mn3 can also be calculated from a relationship of L0.

This step may be carried out in the presence of a base catalyst.

Specific examples of the base catalyst include 1,5,7-triazabicyclo[4.4.0]deca-5-en (TBD) and the like.

The reaction temperature in this step is preferably 50° C. to 200° ° C. and more preferably 80° C. to 180° C.

The reaction time in this step is preferably 10 to 300 hours.

Although the block copolymer that is a triblock copolymer is obtained by the method of producing a block copolymer of the present embodiment, the block copolymers obtained by the method of producing a block copolymer of the present embodiment may also include a block copolymer having three or more blocks.

In the method of producing a block copolymer of the present embodiment, although the constituent unit derived from the (α-substituted) acrylic acid ester at the terminal of the main chain of the block copolymer that is a diblock copolymer and the homopolymer undergo transesterification, the constituent unit derived from an (α-substituted) acrylic acid ester in the second block and the homopolymer may also undergo transesterification. Accordingly, in addition to the block copolymer that is a triblock copolymer, a block copolymer containing a plurality of third blocks can also be produced as a by-product.

### (Block Copolymer)

The block copolymer of the present embodiment contains the first block, the second block, and the third block, which are bonded to one another, and in the block copolymer, the first block and the third block are composed of a polymer having a repeating structure composed of a constituent unit containing an aromatic hydrocarbon group, the second block is composed of a polymer having a repeating structure composed of a constituent unit derived from an (α-substituted) acrylic acid ester, and the third block is bonded to a side chain of the second block via a linking group containing an ester bond.

Among these, it is preferable that the block copolymer is formed of the first block and third block, which are composed of a polymer having a repeating structure composed of a constituent unit represented by General Formula (u1), and the second block, which is composed of a polymer having a repeating structure composed of a constituent unit represented by Formula (u2), and has the terminal of the main chain on the second block side, which is a terminal structure represented by General Formula (e1).

In addition, both the first block and third block have a repeating structure composed of the constituent unit represented by General Formula (u1), but it is preferable to have the different number of the repeating units, and the number of the repeating units in the third block is preferably smaller than that of the first block (Mn3 is smaller than Mn1).

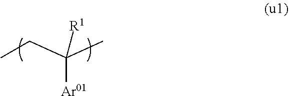

[In the formula, R¹ represents a hydrogen atom, an alkyl group having 1 to 5 carbon atoms, or a halogenated alkyl group having 1 to 5 carbon atoms. Ar⁰¹ represents an aromatic hydrocarbon group.]

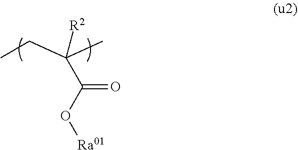

[In the formula, R² represents a hydrogen atom, an alkyl group having 1 to 5 carbon atoms, or a halogenated alkyl group having 1 to 5 carbon atoms. Ra⁰¹ represents an alkyl group having 1 to 10 carbon atoms.]

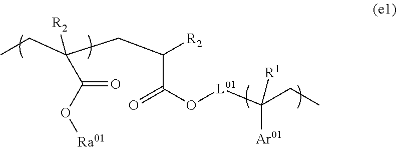

[In the formula, R¹ and R² each independently represent a hydrogen atom, an alkyl group having 1 to 5 carbon atoms, or a halogenated alkyl group having 1 to 5 carbon atoms. Ra⁰¹ represents an alkyl group having 1 to 10 carbon atoms. Ar⁰¹ represents an aromatic hydrocarbon group. L⁰¹ represents a divalent linking group.]

[Constituent Unit Represented by General Formula (u1)]

In General Formula (u1), R¹ is a hydrogen atom, an alkyl group having 1 to 5 carbon atoms, or a halogenated alkyl group having 1 to 5 carbon atoms, and preferably a hydrogen atom.

In General Formula (u1), Ar⁰¹ is an aromatic hydrocarbon group, and examples thereof include the same groups as the aromatic hydrocarbon groups in <<Constituent Unit Containing Aromatic Hydrocarbon Group>> described above.

Among these, Ar⁰¹ is preferably a phenyl group.

[Constituent Unit Represented by General Formula (u2)]

In General Formula (u2), R² is a hydrogen atom, an alkyl group having 1 to 5 carbon atoms, or a halogenated alkyl group having 1 to 5 carbon atoms, and preferably an alkyl group having 1 to 5 carbon atoms, and more preferably a methyl group.

In General Formula (u2), Ra⁰¹ is the alkyl group having 1 to 10 carbon atoms, preferably a linear or branched alkyl group having 1 to 5 carbon atoms, more preferably a methyl group, an ethyl group, a propyl group, an isopropyl group, an n-butyl group, an isobutyl group, a tert-butyl group, a pentyl group, an isopentyl group, and a neopentyl group, and still more preferably a methyl group.

[Terminal Structure Represented by General Formula (e1)]

In General Formula (e1), R¹ and R² are the same as R¹ in General Formula (u1) and R² in General Formula (u2) respectively.

Ra⁰¹ in General Formula (e1) is the same as Ra⁰¹ in General Formula (u2). Ar⁰¹ in General Formula (e1) is the same as Ar⁰¹ in General Formula (u1).

L⁰¹ in General Formula (e1) is a divalent linking group, and preferably an alkylene group having 1 to 10 carbon atoms.

Specific examples of the alkylene group having 1 to 10 carbon atoms include linear alkylene groups such as a methylene group [—CH₂—], an ethylene group [—(CH₂)₂—], a trimethylene group [—(CH₂)₃—], a tetramethylene group [—(CH₂)₄—], a pentamethylene group [—(CH₂)₅—]; branched alkylene groups such as alkylalkylene groups such as an alkylmethylene group such as —CH(CH₃)—, —CH(CH₂CH₃)—, —C(CH₃)₂—, —C(CH₃)(CH₂CH₃)—, —C(CH₃)(CH₂CH₂CH₃)—, or —C(CH₂CH₃)₂—, an alkylethylene group such as —CH(CH₃)CH₂—, —CH(CH₃)CH(CH₃)—, —C(CH₃)₂CH₂—, —CH(CH₂CH₃)CH₂—, or —C(CH₂CH₃)—CH₂—, an alkyltrimethylene group such as —CH(CH₃)CH₂CH₂— or —CH₂CH(CH₃)CH₂—, an alkyltetramethylene group such as —CH(CH₃)CH₂CH₂CH₂— or —CH₂CH(CH₃)CH₂CH₂—.

Among these, L⁰¹ in General Formula (e1) is preferably a linear alkylene group having 1 to 10 carbon atoms, more preferably a linear alkylene group having 1 to 5 carbon atoms, and still more preferably a linear alkylene group having 2 to 5 carbon atoms.

### (Resin Composition for Forming Phase-Separated Structure)

The resin composition for forming a phase-separated structure of the present embodiment contains the above-described block copolymer and an organic solvent component.

### Organic Solvent Component

The resin composition for forming a phase-separated structure of the present embodiment can be prepared by dissolving the above-described block copolymer in an organic solvent component.

Any organic solvent component may be used as long as it can dissolve each component to be used and form a homogeneous solution, and arbitrary solvents may be selected from any solvents known in the related art as a solvent for a composition containing a resin as a main component.

Exemplary examples of the organic solvent component include lactones such as γ-butyrolactone: ketones such as acetone, methyl ethyl ketone, cyclohexanone, methyl-n-pentyl ketone, methyl isopentyl ketone, and 2-heptanone: polyhydric alcohols such as ethylene glycol, diethylene glycol, propylene glycol, and dipropylene glycol; a compound having an ester bond such as ethylene glycol monoacetate, diethylene glycol monoacetate, propylene glycol monoacetate, and dipropylene glycol monoacetate; monoalkyl ether of the polyhydric alcohols or the compounds having the ester bond, such as monomethyl ether, monoethyl ether, monopropyl ether, monobutyl ether, or derivatives of polyhydric alcohols such as the compounds having an ether bond, such as monophenyl ether [among these, propylene glycol monomethyl ether acetate (PGMEA) and propylene glycol monomethyl ether (PGME) are preferable]; cyclic ethers such as dioxane, or esters such as methyl lactate, ethyl lactate (EL), methyl acetate, ethyl acetate, butyl acetate, methyl pyruvate, ethyl pyruvate, methyl methoxy propionate, and ethyl ethoxy propionate: and aromatic organic solvents such as anisole, ethyl benzyl ether, cresyl methyl ether, diphenyl ether, dibenzyl ether, phenetole, butyl phenyl ether, ethyl benzene, diethyl benzene, pentyl benzene, isopropyl benzene, toluene, xylene, cymene, and mesitylene.

The organic solvent component may be used alone or two or more kinds thereof may be used as a mixed solvent. Among these, propylene glycol monomethyl ether acetate (PGMEA), propylene glycol monomethyl ether (PGME), cyclohexanone, and EL are preferable.

A mixed solvent obtained by mixing PGMEA and a polar solvent is also preferable. The blending ratio (mass ratio) may be appropriately determined in consideration of compatibility between PGMEA and the polar solvent, and it is preferably in a range of 1:9 to 9:1 and more preferably 2:8 to 8:2.

For example, in a case where EL is blended as a polar solvent, the mass ratio of PGMEA:EL is preferably 1:9 to 9:1 and more preferably 2:8 to 8:2. In a case where PGME is blended as the polar solvent, the mass ratio of PGMEA:PGME is preferably 1:9 to 9:1, more preferably 2:8 to 8:2, and even more preferably 3:7 to 7:3. In a case where PGME and cyclohexanone are blended as a polar solvent, the mass ratio of PGMEA:(PGME+cyclohexanone) is preferably 1:9 to 9:1, more preferably 2:8 to 8:2, and even more preferably 3:7 to 7:3.

As the organic solvent component in the resin composition for forming a phase-separated structure, in addition to those components, a mixed solvent in which PGMEA, EL, or the mixed solvent of PGMEA and a polar solvent is mixed with y-butyrolactone is also preferable. In this case, the mass ratio of the former to the latter is, as the mixing ratio, preferably 70:30 to 95:5.

The concentration of the organic solvent component included in the resin composition for forming a phase-separated structure is not particularly limited, and the component is appropriately set at a concentration with which the coating can be performed according to the coating film thickness. The solid content concentration is generally used in a range of 0.2% to 70% by mass and preferably in a range of 0.2% to 50% by mass.

### Optional Component

The resin composition for forming a phase-separated structure of the present embodiment may contain an optional component other than the above-described block copolymer and organic solvent component.

Examples of the optional component include another resin, surfactant, dissolution inhibitor, plasticizer, stabilizer, colorant, halation-preventing agent, dye, sensitizer, base multiplier, basic compound, and the like.

### EXAMPLES

Hereinafter, the present invention will be described in more detail based on examples, but the present invention is not limited to the following examples.

### Synthesis Example of Block Copolymer

Block copolymers (BCP1 to 7) were synthesized by the following method according to the method of producing a block copolymer of Examples 1 to 7.

Mn and a copolymerization composition ratio (PS/PMMA) in each of a block copolymer (PS-b-PMMA) containing a block composed of styrene and a block composed of methyl methacrylate used in the method of producing a block copolymer in each example, and a compound represented by Formula (PS-OH) are as shown in Table 1.

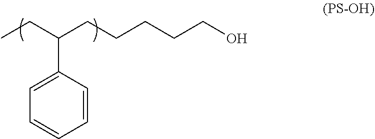

To a flask (30 mL) with a greaseless valve, a stirrer was put, and 500 mg of PS-b-PMMA and the compound represented by Formula (PS-OH) were added in the amounts shown in Table 1, and the resulting mixture was vacuumed at 100° C. in an aluminum bath and dried overnight. After drying, 5 mg (0.0357 mmol) of TBD dissolved in 5 mL of toluene was added to the flask, and the resulting mixture was stirred at 150° C. in the aluminum bath. After stirring, the mixture was cooled to room temperature, and about 5 mg of benzoic acid was then added. Reprecipitation was performed with MeOH at room temperature, and vacuum drying was carried out. A sample (only 300 mg) was dispersed in cyclohexane, stirred at 75° ° C. for 15 minutes, and centrifuged to remove the solvent. This step was carried out three times. After centrifugation, reprecipitation and vacuum drying were carried out to synthesize each block copolymer (PS-b-PMMA-b-PS′).

TABLE 1

| | Adding amount of PS-b-PMMA | Adding amount of PS—OH |
|---|---|---|
| | [mg] | [mg] |
| Example 1 | 500 | 119 |
| Example 2 | 500 | 298 |
| Example 3 | 500 | 99 |
| Example 4 | 500 | 247 |
| Example 5 | 500 | 407 |
| Example 6 | 500 | 179 |

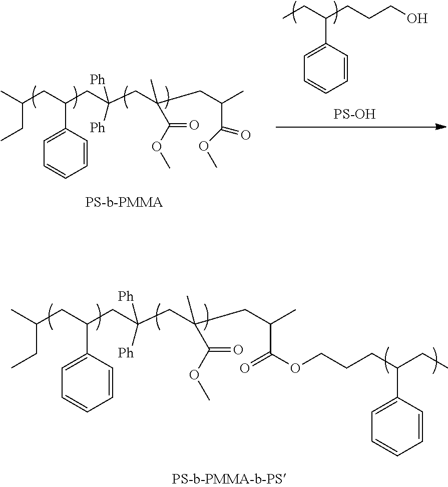

The Mn of (PS-b-PMMA-b-PS′) shown in Table 2 is a number-average molecular weight in terms of standard polystyrene measured by size-exclusion chromatography.

The PS′ substitution rate was calculated from Mn of (PS-b-PMMA) used as a raw material and Mn of (PS-b-PMMA-b-PS′) described above. In a case where the substitution rate is more than 100%, the transesterification occurs on not only the PMMA terminal of PS-b-PMMA but also between the constituent unit derived from methyl methacrylate in the PMMA block and PS-OH.

The copolymerization composition ratio of (PS-b-PMMA-b-PS′) shown in Table 2 was calculated by ¹H-NMR.

TABLE 2

| | | | | | PS′ | | | |
|---|---|---|---|---|---|---|---|---|
| | Block | PS-b-PMMA | | PS′ | Substitution rate | PS-b-PMMA-b-PS′ | | |
| | copolymer | Mn | PS/PMMA | Mn | (%) | Mn | PS/PMMA | PDI |
| Example 1 | BCP1 | 42000 | 50/50 | 2000 | 110 | 44000 | 52/48 | 1.03 |
| Example 2 | BCP2 | 42000 | 50/50 | 5000 | 114 | 48000 | 55/45 | 1.05 |
| Example 3 | BCP3 | 50000 | 50/50 | 2000 | 98 | 52000 | 52/48 | 1.03 |
| Example 4 | BCP4 | 50000 | 50/50 | 5000 | 92 | 55000 | 54/46 | 1.03 |
| Example 5 | BCP6 | 62000 | 45/55 | 10000 | 109 | 73000 | 53/47 | 1.07 |
| Example 6 | BCP7 | 70000 | 50/50 | 5000 | 105 | 75000 | 53/47 | 1.05 |

As shown in Table 2, it could be confirmed that the block copolymer that is a triblock copolymer was produced by the method of producing a block copolymer of Examples.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A method of producing a triblock copolymer, the method comprising:
reacting a diblock copolymer containing a first block formed from a repeating structure comprising a constituent unit containing an aromatic hydrocarbon group, and a second block formed from a repeating structure comprising a constituent unit derived from an acrylic acid ester optionally having a hydrogen atom bonded to the carbon atom at the α-position of the acrylic acid ester substituted with a substituent, with a homopolymer that contains a third block formed from a repeating structure comprising a constituent unit containing an aromatic hydrocarbon group and containing a hydroxy group bonded to a terminal of a main chain in the third block to obtain a triblock copolymer,
wherein the reaction is transesterification of the constituent unit derived from an acrylic acid ester optionally having a hydrogen atom bonded to the carbon atom at the α-position of the acrylic acid ester substituted with a substituent at a terminal of a main chain of the diblock copolymer with the homopolymer.

2. The method of producing a block copolymer according to claim 1, wherein the block copolymer is reacted with the homopolymer such that a mass ratio of the first block and third block to the second block is 25:75 to 75:25.

3. The method of producing a block copolymer according to claim 1, wherein the block copolymer is reacted with the homopolymer such that a ratio Mn1:Mn3 of a number-average molecular weight Mn1 of a polymer constituting the first block to a number-average molecular weight Mn3 of a polymer constituting the third block is 1:0.05 to 1:0.35.

4. The method of producing a block copolymer according to claim 1, wherein a structure of a constituent unit of a polymer constituting the first block is identical to a structure of a constituent unit of a polymer constituting the third block.

5. A block copolymer comprising:
a first block, a second block, and a third block, which are bonded to one another,
wherein the first block and the third block comprise a polymer having a repeating structure comprising a constituent unit containing an aromatic hydrocarbon group,
the second block comprises a polymer having a repeating structure comprising a constituent unit derived from an acrylic acid ester optionally having a hydrogen atom bonded to the carbon atom at the α-position of the acrylic acid ester substituted with a substituent, and
the third block is bonded to a side chain of the second block via a linking group containing an ester bond.

6. The block copolymer according to claim 5, wherein a structure of a constituent unit of a polymer constituting the first block is identical to a structure of a constituent unit of a polymer constituting the third block.
